(19) United States
(12) Patent Application Publication
(10) Pub. No.: US 2018/0023680 A1
(43) Pub. Date: Jan. 25, 2018

(54) WORK APPARATUS WITH HOUSING PARTS CONNECTED VIA A PIVOT JOINT

(71) Applicant: Andreas Stihl AG & Co. KG, Waiblingen (DE)

(72) Inventors: Benjamin Barth, Burgstetten (DE); David Hampe, Stuttgart (DE); Jan Föhrenbach, Fellbach (DE); Tobias Wörner, Korb (DE); Ulrike Neumann, Fellbach (DE)

(21) Appl. No.: 15/645,494

(22) Filed: Jul. 10, 2017

(30) Foreign Application Priority Data
Jul. 21, 2016 (DE) 10 2016 008 935.0

(51) Int. Cl. F16H 57/02; A01G 3/053

(52) U.S. Cl. CPC F16H 57/02; A01G 3/053; A01G 2003/0461

(57) ABSTRACT

A work apparatus has a gear unit which is arranged in a gear housing. The gear unit includes a drive part arranged in a first housing part of the gear housing and an output part arranged in a second housing part. The two housing parts are connected to each other via a pivot joint which permits pivoting of the second housing relative to the first housing part about a pivot axis. The pivot joint has a clamping device for bracing the two housing parts in the direction of the pivot axis. The force exerted with the clamping device on the two housing parts is adjustable via a clamping element. To avoid loosening or releasing of the clamping device even after frequent pivoting, the clamping element moves during clamping in the direction of a clamping axis which encloses an angle α which is more than 10° with the pivot axis.

### CROSS-REFERENCE TO RELATED APPLICATIONS

The present application claims priority of DE 10 2016 008 935.0, filed Jul. 21, 2016, the priority of this application is hereby claimed and this application is incorporated herein by reference.

### BACKGROUND OF THE INVENTION

The invention relates to a work apparatus with housing parts connected via a pivot joint.

It is known in work apparatuses to provide a pivot joint via which the position of two housing parts of the work apparatus is adjustable. As a result, in particular, the position of a tool of the work apparatus is adapted to the use situation.

DE 197 53 361 A1 discloses a work apparatus, namely a brush-cutting apparatus with a hedge trimmer accessory set. The gear head of the hedge trimmer accessory set comprises a drive shaft mounted in a first housing part and an output shaft mounted in a second housing part. Drive shaft and output shaft are coupled via a central wheel which rotates about a bearing shaft arranged perpendicular to the drive shaft and output shaft. In order to adjust the position of the two housing parts with respect to each other, the two housing parts are connected to each other via a releasable clamping device which braces the two housing parts together in the direction of the bearing shaft. The clamping device comprises a clamping shaft, on the one end of which a clamping nut is screwed which is supported on the housing. The other end of the clamping shaft is mounted on an eccentric clamping head to which a clamping lever is fixed.

During the adjustment, the two housing parts move with respect to each other about the bearing shaft. As a result, the supporting points of the clamping nut and of the clamping lever also move about the bearing shaft. During an adjustment of the two housing parts with respect to each other, it has to be avoided that the clamping nut can rotate in relation to the clamping shaft and can thereby bring about a loosening of the clamping device.

### SUMMARY OF THE INVENTION

The invention is based on the object of providing a work apparatus of the type in question, in which a reduction of the clamping force due to the pivoting movement of the two housing parts with respect to each other is avoided in a simple manner.

This object is achieved by a work apparatus with a gear unit which is arranged in a gear housing, wherein the gear unit has a drive part arranged in a first housing part of the gear housing and an output part arranged in a second housing part, wherein the two housing parts are connected to each other via a pivot joint which permits pivoting of the second housing part in relation to the first housing part about a pivot axis, wherein the pivot joint has a clamping device for bracing the two housing parts in the direction of the pivot axis, wherein the force exerted with the clamping device on the two housing parts is adjustable via a clamping element, wherein the clamping element moves during clamping in the direction of a clamping axis, wherein the clamping axis encloses an angle which is more than 10° with the pivot axis.

It is provided that the clamping element moves during clamping in the direction of a clamping axis which encloses an angle α of more than 10° with the pivot axis. As a result, the clamping axis is not oriented in the direction of the pivot axis, but rather is inclined with respect thereto, rotation of the clamping element in relation to the housing parts is avoided in a simple manner during movement of the two housing parts with respect to each other about the pivot axis. A complicated securing of the position of the clamping element in relation to a clamping bolt or the like is unnecessary. The securing of the position is already achieved by the arrangement of the clamping axis with respect to the pivot axis at an angle of more than 10°.

The angle is advantageously more than 45°, in particular approximately 90°. The angle is here at maximum 90°. A simple configuration arises if the clamping device comprises a threaded connection. The clamping axis here is advantageously the center axis of the threaded connection. If the clamping axis is arranged offset with respect to the pivot axis, the clamping axis runs parallel to the center axis of the threaded connection and intersects the pivot axis. The threaded connection preferably acts between the clamping element and the gear housing. In DE 197 53 361 A1, the threaded connection acts between the clamping bolt and the clamping nut. By contrast, in the present invention, a threaded connection between the clamping element and the gear housing is provided.

A compact construction is achieved if the pivot axis intersects a component of the gear unit. The pivot axis particularly preferably intersects a bearing of the output part. Owing to the fact that at least one component of the gear unit, in particular a bearing of the output part, is arranged in the region of the pivot axis, a compact construction is achieved. The pivot axis does not project here merely through an opening of the central wheel while drive wheel and output wheel already end before the pivot axis, as in the prior art, but rather runs over at least one length portion in the material of a component of the gear unit.

The pivot joint advantageously has a clamping bolt on which the clamping element acts. The clamping bolt advantageously has a clamping portion with which the clamping element interacts in order to adjust the clamping force. The clamping portion of the clamping bolt advantageously encloses an angle of more than 20° with the pivot axis. The clamping portion of the clamping bolt particularly preferably encloses an angle of more than 30°, in particular of more than 40°, with the pivot axis. By means of the oblique position of the clamping portion in relation to the pivot axis, the movement of the clamping element in the direction of the pivot axis can be converted in a simple manner into a movement of the clamping bolt in the direction of the pivot axis running obliquely with respect thereto. The clamping portion permits a simple construction. The clamping bolt particularly preferably has a conical depression on which the clamping portion is formed. Securing of the rotational position of the clamping bolt in relation to the clamping element is achieved at the same time via the conical depression. However, it can also be provided that the clamping bolt has a ramp-shaped portion which forms the clamping portion. A different configuration of the clamping portion may also be advantageous.

The clamping bolt advantageously projects through one of the housing parts and has a free end which lies within the other housing part. As a result of the fact that the clamping bolt ends within one of the housing parts, the clamping bolt can be of comparatively short design. An imaginary extension of the clamping bolt into the other housing part advantageously intersects a component of the gear unit, in particular a bearing of the output part. As a result, a compact construction is achieved. The clamping portion is preferably arranged adjacent to the free end of the clamping bolt.

The clamping device advantageously has at least one spring which acts between the clamping bolt and a housing part. The two housing parts can be braced in the direction of the pivot axis via the spring. A disk is advantageously arranged between the at least one spring and a contact surface of the housing part. The disk is in particular secured against rotation in relation to the housing part. In particular in the case of housing parts which are composed of materials sensitive to friction, such as, for example, magnesium, it can be ensured by the disk which is secured against rotation in relation to the housing part that, when the two housing parts rotate with respect to each other, no rotation takes place relative to a contact surface of the housing part. Rather, the clamping bolt rotates in relation to the disk. The at least one spring here can rotate with the clamping bolt or can lie against the disk. This is dependent on the prevailing friction conditions. However, securing the spring against rotation in relation to the clamping bolt or the housing or the disk may also be advantageous. It is thus structurally defined between which components the relative rotation takes place. A simple structural configuration arises if the disk is secured against rotation in relation to the housing part by a form-fitting connection.

The work apparatus advantageously has a shaft which connects a motor housing to the gear housing. The first housing part is advantageously connected fixedly to the shaft. The work apparatus is preferably a hedge cutter. A cutter arrangement which comprises at least one cutter bar driven in a reciprocating manner is in particular secured to the second housing part. In particular for hedge cutters, an orientation of the cutter arrangement via a pivot joint between two housing parts of the gear housing is advantageous.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a schematic illustration of a hedge cutter,

FIG. 2 shows a perspective illustration of a portion of the gear housing of the hedge cutter from FIG. 1,

FIG. 3 shows an exploded illustration of the gear housing,

FIG. 4 shows a schematic illustration of the gear unit,

FIG. 5 shows a section through the gear housing,

FIG. 6 shows an enlarged illustration of the region of a clamping element from FIG. 6, and

FIG. 7 shows an enlarged illustration of the region of a receptacle for the clamping bolt in FIG. 3.

### DETAILED DESCRIPTION OF THE INVENTION

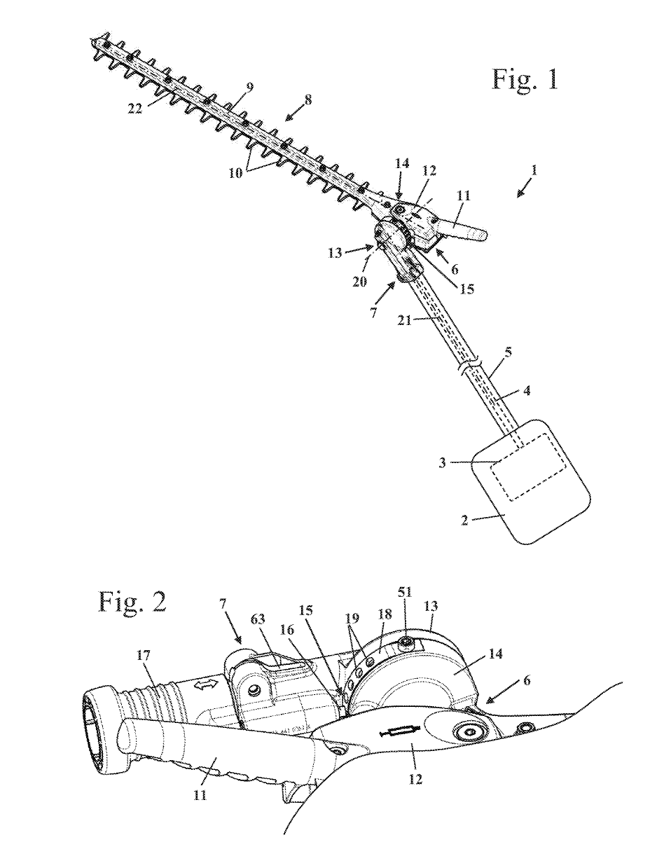

FIG. 1 shows a hedge cutter 1 as an exemplary embodiment of a work apparatus. The hedge cutter 1 is a handheld work apparatus and is provided for cutting hedges or the like, in particular hedges which are comparatively high or to which access is difficult. To this end, the hedge cutter 1 has a motor housing 2 which is carried by the operator and which is connected via a shaft 5 to a gear housing 6. A cutter arrangement 8 for cutting the hedge, said cutter arrangement, in the exemplary embodiment, comprising two cutter bars 10 mounted on a guide 9, is arranged on the gear housing 6. The cutter bars 10 have a longitudinal axis 22, in the direction of which they are driven in a reciprocating manner.

In order to be able to adjust the orientation of the cutter bars 10 so as to be adapted to the particular application, the gear housing 6 has a first housing part 13 secured on the shaft 5 and a second housing part 14 on which the cutter bars 10 are arranged. The two housing parts 13 and 14 are pivotable in relation to each other about a pivot axis 20. An adjustment device 15 is provided for adjusting the pivoting position. A handle part 12 is arranged on the second housing part 14, said handle part comprising an adjustment handle 11 via which the pivoting position of the cutter arrangement 8 in relation to the shaft 5 can easily be adjusted by the operator. A drive motor 3 which is arranged in the motor housing 2 is provided for driving the cutter arrangement 8. The drive motor 3 is preferably an internal combustion engine, in particular a two cylinder motor, preferably a two stroke motor or a mixture-lubricated four stroke motor. However, the drive motor 3 can also be an electric motor which can be supplied with power by cable or by a battery. The drive motor 3 rotatingly drives a drive shaft 4 which is mounted in the shaft 5. The drive shaft 4 rotates about a longitudinal axis 21 of the shaft 5.

The first housing part 13 is fixed to the shaft 5 via a fixing device 7. The fixing device 7 is shown in FIG. 2. On the fixing device 7, the first housing part 13 has a longitudinal slot 63 which runs in the longitudinal direction of the shaft 5. The two portions of the first housing part 13 that are separated from each other by the longitudinal slot 63 can be pulled towards each other via clamping screws or the like and the housing part 13 can thereby be securely clamped on the shaft 5.

FIG. 2 also shows the adjustment device 15 in detail. The adjustment device 15 comprises an adjustment sleeve 17 which engages around the shaft 5 (FIG. 1). The adjustment sleeve 17 is not shown in FIG. 1. The adjustment sleeve 17 is adjustable in relation to the shaft 5 in the direction of the longitudinal axis 21. A pin 16 which engages in a perforated plate 18 arranged on the second housing part 14 is fixed to the adjustment sleeve 17. The perforated plate 18 has a multiplicity of openings 19 which are arranged distributed over the circumference of the second housing part 14 and in which the pin 16 can engage. Each opening 19 is assigned to a pivoting position of the second housing part 14 in relation to the first housing part 13. The perforated plate 18 is fixed to the second housing part 14 via fastening screws 51. A different structural configuration of the openings 19 may also be advantageous.

In order to adjust the pivoting position of the cutter arrangement 8 in relation to the shaft 5, the operator pulls the adjustment sleeve 17 in the direction of the motor housing 2. As a result, the pin 16 passes out of the opening 19, and the second housing part 14 is pivotable in relation to the first housing part 13. For the pivoting, the operator can grip the second housing part 14 by means of the adjustment handle 11 and can pivot same about the pivot axis 20 (FIG. 1) until the desired orientation is reached. The adjustment sleeve 17 is subsequently displaced in the direction of the first housing part 13, and therefore the pin 16 passes into an opening 19 and thereby fixes the orientation of the housing parts 13 and 14 with respect to each other. The adjustment sleeve 17 is preferably spring-mounted in the direction of the first housing part 13, and therefore, after the adjustment of a desired orientation of the housing parts 13 and 14 with respect to each other, the operator merely has to let go of the adjustment sleeve 17. The two housing parts 13 and 14 are subsequently braced in relation to each other.

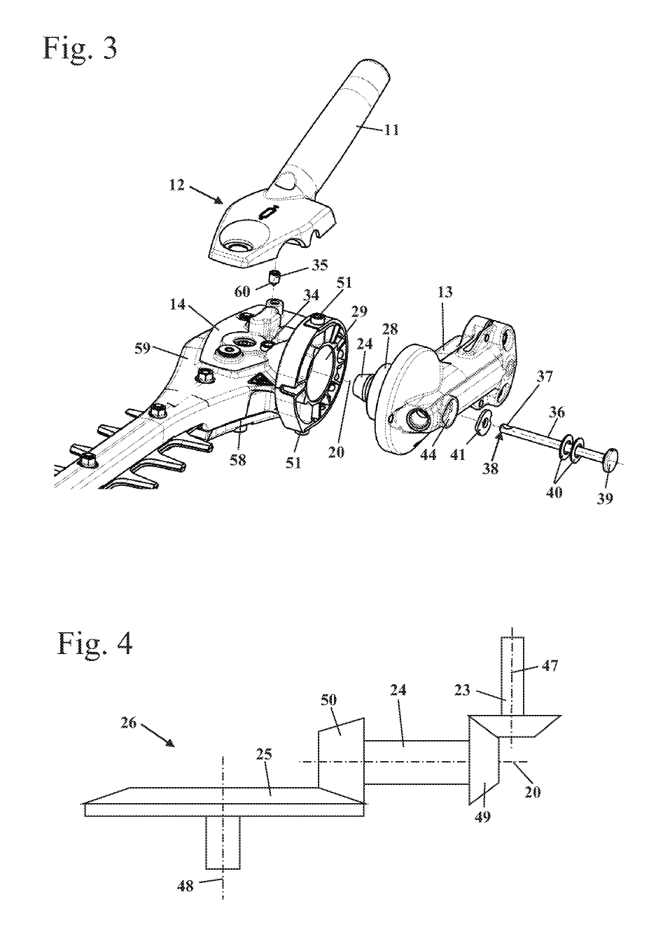

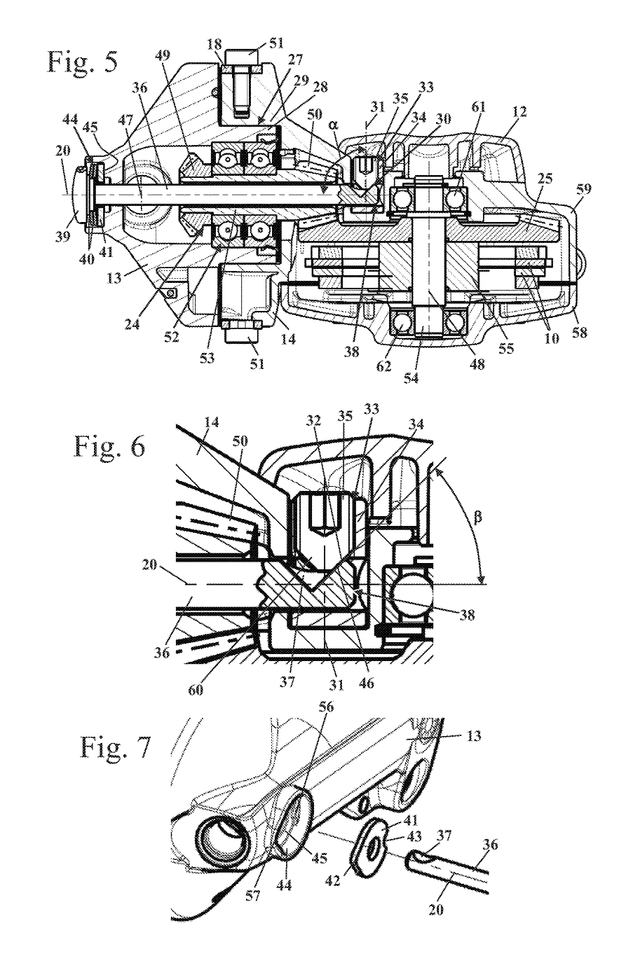

As FIG. 3 shows, the first housing part 13 has, on the side facing the second housing part 14, a bearing pin 28 which is provided for engagement in a bearing bushing 29 of the second housing part 14. The bearing pin 28 and the bearing bushing 29 form a pivot joint 27 (FIG. 5) for pivoting the two housing parts 13, 14 in relation to each other. In order to brace the two housing parts 13 and 14 in relation to each other, a clamping bolt 36 is provided which projects through the first housing part 13 into the second housing part 14. The adjusted pivoting position is secured by the bracing of the two housing parts 13 and 14 in relation to each other. The clamping bolt 36 has a head 39 which is supported in relation to the first housing part 13 in the direction of the pivot axis 20. The pivot axis 20 is at the same time the longitudinal center axis of the clamping bolt 36. The clamping bolt 36 is supported in relation to the first housing part 13 via a disk 41 and two springs 40. In the exemplary embodiment, the springs 40 are designed as disk springs. A different number and/or a different configuration of the springs 40 may also be advantageous.

The clamping bolt 36 projects through the springs 40 and the disk 41. The disk 41 and the springs 40 are arranged in a receptacle 44 of the first housing part 13. As FIG. 3 also shows, the clamping bolt 36 has, adjacent to a free end 38, a depression 37 which, in the exemplary embodiment, is of conical design. The depression 37 extends from the outer circumference of the clamping bolt 36 in the direction of the pivot axis 20. In the exemplary embodiment, the center axis of the conical depression 37 runs perpendicularly to the pivot axis 20. In the exemplary embodiment, the pivot axis 20 intersects the conical depression 37, as FIG. 5 shows. A threaded bushing 34 which extends perpendicularly to the pivot axis 20 is pressed in in the second housing part 14. A screw, a grub screw 35 in the exemplary embodiment, is screwed into the threaded bushing 34. The grub screw 35 has a conical tip 60 which, in the mounted state of the arrangement, projects into the conical depression 37 of the clamping bolt 36. In the mounted state of the arrangement, the grub screw 35 is covered by the handle part 12.

As FIG. 3 also shows, the second housing part 14 has an upper housing shell 59 in which the bearing bushing 29 and the threaded bushing 34 are arranged, and a lower housing shell 58 which closes the second housing part 14. A central wheel 24 which is part of the gear unit 26 shown in FIG. 4 can also be seen in FIG. 3.

The gear unit 26 is merely shown schematically in FIG. 4. The gear unit 26 has a drive wheel 23, the drive axis 47 of which is oriented in the direction of the longitudinal axis 21 of the shaft 5 (FIG. 1). The drive axis 47 advantageously coincides with the longitudinal axis 21. The drive wheel 23 meshes with an inlet wheel 49 of the central wheel 24. The central wheel 24 rotates about the axis of rotation 20. The central wheel 24 has an outlet wheel 50 which meshes with an output wheel 25. The output wheel 25 rotates about an output axis 48. The output axis 48 is oriented perpendicular to the longitudinal axis 22 of the cutter arrangement 8. The output axis 48 is advantageously perpendicular to the plane of the cutter bars 10 (FIG. 1). During rotation of the second housing part 14 in relation to the first housing part 13, the axes 47 and 48 pivot relative to each other about the pivot axis 20.

FIG. 5 shows a section through the gear housing 6 in a position in which drive axis 47 (FIG. 4) and output axis 48 (FIGS. 4 and 5) are arranged perpendicular to each other. In FIG. 5, the drive axis 47 is accordingly arranged perpendicular to the plane of the sheet. As FIG. 5 shows, the inlet wheel 49 and the outlet wheel 50 of the central wheel 24 are designed as separate components. The outlet wheel 50 is formed integrally with a bearing shaft 53 on which the inlet wheel 49 is fixed. The bearing shaft 53 is mounted rotatably in the first housing part 13 by way of a bearing 52 which, in the exemplary embodiment, is designed as a rolling bearing. In the exemplary embodiment, the bearing 52 is formed by two ball bearings. The bearing shaft 53 is designed as a hollow shaft. The clamping bolt 36 projects completely through the central wheel 24. The outlet wheel 50 of the central wheel 24 meshes with the output wheel 25 which is mounted on a bearing shaft 54 so as to be rotatable about the output axis 48. The bearing shaft 54 is mounted in the upper housing shell 59 of the second housing part 14 by way of a bearing 61, in the exemplary embodiment a rolling bearing, namely a ball bearing, and is mounted in the lower housing shell 58 by way of a bearing 62 which, in the exemplary embodiment, is likewise designed as a rolling bearing, namely as a ball bearing. An eccentric 55 which, as customary, drives the cutter bars 10 in a reciprocating manner is arranged between the output wheel 25 and the bearing 62.

As FIG. 5 shows, the free end 38 of the clamping bolt 36 ends before the bearing 61. The pivot axis 20 and an imaginary extension of the clamping bolt 36 intersect the bearing 61.

FIG. 5 also shows the arrangement of the springs 40 and of the disk 41 in the receptacle 44. As FIG. 5 shows, the receptacle 44 has a contact surface 45 which forms the bottom of the receptacle 44 and against which the disk 41 lies. The head 39 of the clamping bolt 36 lies against a spring 40. In the exemplary embodiment, the head 39 is arranged outside the receptacle 44. However, an arrangement within the receptacle 44 may also be advantageous.

In order to fix the two housing parts 13 and 14 in relation to each other, a clamping device 30 is provided. The clamping device 30 comprises the clamping bolt 36 with the springs 44 and the disk 41, and also the grub screw 35. The grub screw 35 is held in the second housing part 14 via a threaded connection 33. The threaded connection 33 is formed between the threaded bushing 34, which is fixed securely in the second housing part, and the outer thread of the grub screw 35. If the grub screw 35 is screwed into the second housing part 14, it moves into the second housing part 14 in the direction of a clamping axis 31. The clamping axis 31 is the central axis of the threaded connection 33. The clamping axis 31 encloses an angle α with the pivot axis 20. The angle α is more than 10°, preferably more than 45°. The angle α is preferably approximately 90°. In the exemplary embodiment, an angle α of 90° is provided.

The angle α is dimensioned here in such a manner that it is not more than 90°.

As FIG. 6 shows, the tip 60 of the grub screw 35 lies in the conical depression 37. The grub screw 35 lies here with a contact surface 32 formed on the tip 60 against a clamping portion 46 of the conical depression 37. The clamping portion 46 is that flank of the depression 37 which faces the free end 38 and faces away from the head 39. In the exemplary embodiment, the contact surface 32 and the clamping portion 46 run parallel to each other. The contact surface 32 here is only that region of the grub screw 35 which is actually connected to the clamping bolt 36. The clamping portion 46 is only that region of the depression 37 against which the grub screw 35 lies with its contact surface 32. The clamping portion 46 encloses an angle β which is more than 20°, in particular more than 30° and preferably more than 40°, with the pivot axis 20. In the exemplary embodiment, an angle β of approximately 45° is provided. If the grub screw 35 is screwed in the clamping direction 31 into the housing part 14 and therefore into the clamping bolt 36, a force is thereby exerted on the clamping bolt 36 into the housing part 14, i.e. to the right in FIG. 6. As a result, the head 39 is pressed against the springs 40 (FIG. 5), and therefore the springs 40 are pretensioned. The pretensioning between the two housing parts 13 and 14 can thus be adjusted via the screw-in depth of the grub screw 35. Since the clamping direction 31 is at an angle to the pivot axis 20, the grub screw 35 is not rotated in relation to the clamping bolt 36 by the pivoting of the two housing parts 13 and 14 with respect to each other, and therefore an unintentional loosening of the pretensioning of the two housing parts 13 and 14 with respect to each other is avoided.

During the rotation of the two housing parts 13 and 14 with respect to each other, the clamping bolt 36 rotates in relation to the first housing part 13 since the orientation of the clamping bolt 36 in relation to the second housing part 14 is defined via the grub screw 35 and the conical depression 37 (FIGS. 5 and 6). In order to avoid a relative movement taking place on the first housing part 13, the disk is secured in its rotational position in relation to the first housing part 13, as FIG. 7 shows. In the exemplary embodiment, a form-fitting securing is provided. The disk 41 has a securing portion 42 which is designed as a lug and at which the radius of the disk 41 is enlarged. On the opposite side, the disk 41 has a securing portion 43 which is provided as a depression on the outer circumference of the disk 41. As FIG. 7 shows, the circumferential wall of the receptacle 44 is provided with a protrusion 57. An elevation 56 is arranged on the opposite side of the receptacle 44. In the mounted state, the securing portion 42 projects into the protrusion 57 and the elevation 56 projects into the securing portion 43. As a result, the disk 41 is secured in a form-fitting manner on the housing part 13 and cannot rotate with the clamping bolt 36 about the pivot axis 20. Wear due to friction on the receptacle 44 of the housing part 13 is thereby avoided in a simple manner.

Instead of the threaded connection, a different fixing of the clamping bolt 36, for example via a clamping element or the like pressed into the second housing part, may also be advantageous. It may also be advantageous for the head 39 of the clamping bolt 36 to be supported on the second housing part 14 and for the free end 38 of the clamping bolt 36 to project into the first housing part 13. A different arrangement of the springs 40 may also be expedient. Provision may also be made to provide one or both of the springs 40 with a means for securing against rotation, and therefore the one spring or both springs 40 is or are secured in a form-fitting manner on the housing part 13. In this configuration, the disk 41 can be omitted.

While specific embodiments of the invention have been shown and described in detail to illustrate the inventive principles, it will be understood that the invention may be embodied otherwise without departing from such principles.

We claim:

1. A work apparatus, comprising: a gear housing having a first housing part and a second housing part, wherein the two housing parts are connected to each other via a pivot joint which permits pivoting of the second housing part in relation to the first housing part about a pivot axis, and a gear unit arranged in the gear housing, wherein the gear unit has a drive part arranged in the first housing part of the gear housing and an output part arranged in the second housing part, wherein the pivot joint includes a clamping device for bracing the two housing parts in a direction of the pivot axis, wherein the force exerted with the clamping device on the two housing parts is adjustable via a clamping element, wherein the clamping element moves during clamping in a direction of a clamping axis, wherein the clamping axis encloses an angle α which is more than 10° with the pivot axis.

2. The work apparatus according to claim 1, wherein the angle α is more than 45°.

3. The work apparatus according to claim 1, wherein the clamping device comprises a threaded connection, and the clamping axis is a center axis of the threaded connection.

4. The work apparatus according to claim 3, wherein the threaded connection is arranged to act between the clamping element and the gear housing.

5. The work apparatus according to claim 1, wherein the pivot axis intersects a component of the gear unit.

6. The work apparatus according to claim 1, wherein the pivot joint includes a clamping bolt on which the clamping element acts.

7. The work apparatus according to claim 6, wherein the clamping bolt has a clamping portion that interacts with the clamping element to adjust the clamping force, wherein the clamping portion of the clamping bolt encloses an angle β of more than 20° with the pivot axis.

8. The work apparatus according to claim 7, wherein the clamping bolt has a conical depression on which the clamping portion is formed.

9. The work apparatus according to claim 6, wherein the clamping bolt projects through one of the housing parts, and the clamping bolt has a free end that lies within the other of the housing parts.

10. The work apparatus according to claim 9, wherein the clamping portion is arranged adjacent to the free end of the clamping bolt.

11. The work apparatus according to claim 6, wherein the clamping device includes at least one spring arranged to act between the clamping bolt and one of the housing parts.

12. The work apparatus according to claim 11, wherein a disk is arranged between the at least one spring and a contact surface of the one housing part, and the disk being secured against rotation in relation to the one housing part.

13. The work apparatus according to claim 12, wherein the disk being secured against rotation relative to the one housing part by a form-fitting connection.

14. The work apparatus according to claim 1, further comprising a shaft that connects a motor housing to the gear housing, wherein the first housing part is fixedly connected to the shaft.

15. The work apparatus according to claim 1, wherein the work apparatus is a hedge cutter, and further comprising a cutter arrangement, which includes at least one cutter bar driven in a reciprocating manner secured on the second housing part.
